(19) United States
(12) Patent Application Publication
(10) Pub. No.: US 2006/0082843 A1
(43) Pub. Date: Apr. 20, 2006

(54) Method and system for calibration and characterization of joint nonlinear and linear transformations for a color input or output device

(75) Inventors: Hong Li, Superior, CO (US); Gerhard R. Thompson, Wappingers Falls, NY (US); Chai Wah Wu, Poughquag, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/963,641

(22) Filed: Oct. 14, 2004

(51) Int. Cl. H04N 1/46

(52) U.S. Cl. 358/504

(57) ABSTRACT

A method and system for calibrating a color input or output device by simultaneously solving non-linear and linear transformations includes minimizing any error between two sets of corresponding data set of the color device.

### BACKGROUND OF THE INVENTION

1. Field of the Invention

The present invention generally relates to a system and method for calibration and/or characterization of joint nonlinear and linear transformations for a color input or output device. More particularly, the present invention relates to a method and system that calibrates and/or characterizes a color input or output device through the simultaneous solution of the non-linear and linear transformations via minimization of error between a transformed first data set obtained from the color device and the corresponding second data set obtained from measured or published data.

2. Description of the Related Art

Calibration of color input devices such as, for example, scanners, and color output devices such as, for example, displays and color printers, requires a determination of the transformation between two data sets from test charts, a data set in a first color space obtained from the color input or output device, and a data set in a second color space from measured or published data, with a correspondence between points in the two data sets.

In general, for color devices, the first color space is the device color space (usually RGB, i.e. red, green and blue, or CMYK, etc.) and the second color space is a calorimetric color space (usually XYZ or L*a*b*, as defined by, for example, the International Commission on Illumination (CIE)).

While the following description describes a transformation from an RGB color space for a device to a colorimetric XYZ color space, it is straightforward to consider the inverse transformation and the transformation between other color spaces.

Conventionally, as illustrated by the flowchart of FIG. 1, the non-linearity in each of the RBG color space channels are first determined in step S100, by measuring the RGB values output from the color device when only gray values are input to the color device. For example, in the case of a scanner, a series of gray patches may be scanned for each of the RGB channels. The output for each of the RGB channels is then compared to the input gray values and the non-linearity of each of the RGB channels may then be determined.

The non-linearity of each of the RGB channels is represented by a tone reproduction curve for each of the three primary colors in the RGB color space. These tone reproduction curves linearize the input RGB values with respect to luminance and can be obtained by a variety of curve fitting techniques.

Next, in step S102, a linear transformation between the linearized RGB color space and the XYZ color space is determined by minimizing the least square error.

Finally, in step S104, the combination of the tone reproduction curves and the linear transformation is used to generate the transformation between RGB device values and XYZ calorimetric values, which can be used for calibrating or characterizing the device.

Therefore, conventionally, the transformation is obtained in two stages. First, the conventional methods and systems require linearizing the input RGB values with respect to luminance in step S100 and then, subsequently, determining the linear transformation between the linearized RGB color space and the XYZ color space in step S102. Thus, a two-step process is required before the transformation between the input RGB values and the XYZ values is obtained.

Because of this two stage process, the obtained transformation is suboptimal. Furthermore, the first stage requires many gray patches to be used and, thus, many data points are needed to obtain the transformation.

### SUMMARY OF THE INVENTION

In view of the foregoing and other exemplary problems, drawbacks, and disadvantages of the conventional methods and structures, an exemplary feature of the present invention is to provide a method and structure in which color devices are calibrated and/or characterized.

In a first exemplary embodiment of the present invention, a method of calibrating or characterizing a color device transforms values in a first color space to obtain values in a second color space, and minimizes the error between the transformed values in the second color space and a set of corresponding published or measured values in the second color space.

In a second exemplary embodiment of the present invention, a system for calibrating a color device includes means for transforming values in a first color space to obtain values in a second color space, and means for minimizing the error between the transformed values in the second color space and a set of corresponding published or measured values in the second color space.

In a third exemplary embodiment of the present invention, a method for deploying computing infrastructure includes integrating computer-readable code into a computing system. The computer-readable code includes instructions for transforming values in a first color space to obtain values in a second color space, and instructions for minimizing the error between the transformed values in the second color space and a set of corresponding published or measured color values in the second color space.

In a fourth exemplary embodiment of the present invention, a system for calibrating a color device includes a first processor that transforms measured color values in a first color space to obtain measured color values in a second color space, and a second processor that minimizes the error between values computed in the second color space and the measured color values in the second color space.

In contrast to the above-described conventional calibration process, an exemplary embodiment of the method and system of the present invention significantly reduces the data set that is required to perform the calibration by reducing the number of stages that are performed in the transformation in order to minimize the error in the calibration process.

Further, an exemplary embodiment of the present invention is capable of significantly reducing the errors in the calibration process compared with the conventional calibration process.

An exemplary method in accordance with the present invention is a one-step process which simultaneously determines the tone reproduction curves and the linear matrix color space transformation.

In another exemplary embodiment of the present invention, the error may be minimized by expressing the errors in the L*a*b* color space, rather than by using the XYZ color space. In this manner, the error in the calibration process may be further reduced, especially with respect to the perceived color output of the color device.

In an exemplary embodiment of the present invention, the number of gray patches needed to obtain the transformation can be small or even zero.

In addition, the calibration and characterization steps in conventional methods require the use of a specialized set of data. In the scanner case, this would, for example, be the data obtained by scanning in an IT8/Q60 color target or a GretagMacbeth color checker chart.

In contrast, an exemplary embodiment of the present invention works with a much broader range of data sets including those derived from an image itself. In other words, a standard color target is not necessary, and a smaller data set can be sufficient for calibration/characterization.

With an exemplary embodiment of the present invention, since a standard set of patches is not needed for the calibration/characterization, the determination of the transform parameters may be obtained using normal images.

Conventional systems perform calibration/characterization using a specialized set of data (e.g. using an IT8/Q60 color target in a scanner). In contrast, an exemplary embodiment of the invention performs calibration and/or characterization using data that may be the general images that are scanned or displayed by the device during normal use. This allows for online continuous calibration/characterization of the device.

These and many other advantages may be achieved with the present invention.

### BRIEF DESCRIPTION OF THE DRAWINGS

The foregoing and other exemplary purposes, aspects and advantages will be better understood from the following detailed description of exemplary embodiments of the invention with reference to the drawings, in which:

FIG. 1 is a flowchart that illustrates a conventional method for calibrating a color device;

FIG. 2 is a flowchart that illustrates a method for calibrating a color device in accordance with an exemplary embodiment of the present invention;

FIG. 3 illustrates an exemplary calibration system 300 in accordance with the present invention; and

FIG. 4 illustrates a signal bearing medium 400 (e.g., storage medium) for storing steps of a program of a method according to the present invention.

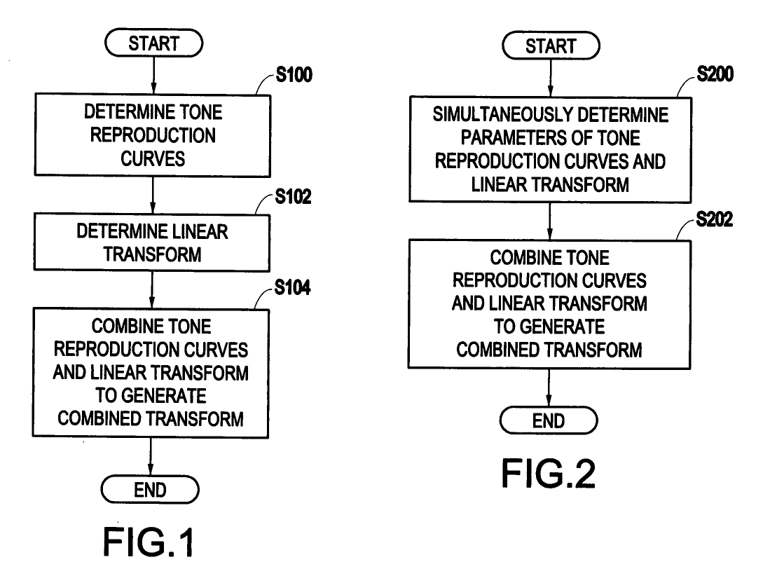

### DETAILED DESCRIPTION OF EXEMPLARY EMBODIMENTS OF THE INVENTION

Referring now to the drawings, and more particularly to FIGS. 2-4, there are shown exemplary embodiments of the methods and systems in accordance with the present invention.

As explained above, conventional calibration methods and systems require a two-step process to optimize linear and non-linear transforms and are only capable of providing sub-optimal solutions. In stark contrast, an exemplary embodiment of the present invention is capable of providing an optimal or near-optimal solution by simultaneously optimizing the non-linear and the linear transformations.

As illustrated by FIG. 2, an exemplary embodiment of the present invention accomplishes this optimization by varying the parameters of the non-linear and linear transformations simultaneously in step S200 and then the combined transform between the values in a first color space and the values in a second color space is used for calibration and/or characterization of the color device in step 202.

In the conventional two-step approach, the non-linearity is determined by measuring a number of gray patches, and creating tone reproduction curves to linearize the raw RGB values with respect to the luminance Y.

In stark contrast, in an exemplary embodiment of the present invention, there is no need to have a large series of gray patches for linearization.

Rather, both the linearization and the 3×3 transform matrix may be simultaneously derived using a single calibration chart. Even calibration charts without a large series of gray patches may be used.

Further, both the linearization and the 3×3 transform matrix may be determined using only a small number of measurement data. Therefore, an exemplary embodiment of the present invention may be used to calibrate a color device using “normal” images (for example, images that are not only used for the purpose of calibration) and a XYZ colorimetric measurement device. Therefore, this exemplary embodiment obviates any need for a specialized calibration chart. This opens up the possibility for online continuous calibration.

In other words, an exemplary embodiment of the present invention permits calibration and/or characterization of a color device while the color device is performing its normal functions and without requiring the interruption in the use of the color device to calibrate the device.

In the exemplary embodiment of the present invention that uses “normal” images for calibration/characterization, the image may be divided into several regions, and the RGB data in each region may be averaged to create a RGB value. Corresponding regions may be captured by a low-resolution, XYZ colorimetric measurement device to obtain corresponding XYZ color space values. The pairs of measurement values in all the regions may then be used for the calibration methods and systems in accordance with the present invention.

Additionally, in another exemplary embodiment of the present invention, to improve robustness in the XYZ data, the XYZ color space values may be measured by the XYZ calorimetric measuring device after passing the image through a low pass filter.

In addition, in an exemplary embodiment of the present invention, the optimization may be done by minimizing the error expressed in the L*a*b color space, in order to minimize perceptual color errors in the calibration/characterization.

In an exemplary embodiment of the present invention, the calibration of a color device may begin by obtaining two sets of corresponding color values, one set in the device color space, and another set in a colorimetric color space.

For example, in the case of calibrating a scanner, a standard calibration test chart having known color values may be scanned and the color values output by the scanner in the device color space are obtained.

Alternatively, the color values of a standard calibration test chart may not be known, but may be determined using a colorimetric measuring device.

In the case of a display or a color printer, known values in the device color space may be electronically input to the color device and the output from the display or color printer may be measured using a colorimetric measuring device to obtain corresponding values in the calorimetric color space.

In the case of a color printer, typical color printers operate in the CMY or CMYK device color space. Therefore, in a similar manner, in an exemplary embodiment of the present invention, the color values that are input to the color printer should be in the CMY or CMYK device color space and the output from the colorimetric measuring device should be in the CIE L*a*b or the CIE XYZ colorimetric space.

In the case of CMYK color space, an additional transformation may be needed between the CMYK color space and the CMY color space. Such a transformation may include, for example, black generation and undercolor removal.

In an exemplary embodiment of the present invention, the values in the device color space are compared with the corresponding colorimetric color space values to determine a tone reproduction (or a gamma) curve model.

In general, a tone reproduction curve is used to linearize the channels in the device color space with respect to luminance in the colorimetric color space.

An exemplary tone reproduction curve model includes a polynomial for each of the channels of the device color space. For the RGB color space, these polynomials may be expressed as:
R′=fᵣ(R); (1)
G′=f_{g}(G); and (2)
B′=f_{b}(B). (3)

where: fᵣ, f_{g}, and f_{b} are the three tone reproduction curve polynomials describing the non-linearity of each channel.

The order of the tone reproduction curve polynomials may be increased to increase the accuracy. However, any increase in the order correspondingly increases complexity and may adversely affect the performance of the calibration. Therefore, in an exemplary embodiment of the present invention the tone reproduction curves may be implemented as three, one-dimensional, look-up tables.

In the case of a gamma curve, an exponential term may also be included in the non-linearity.

Next, the linear transformation between the R′, G′, B′ values and the XYZ color space may be expressed as a 3-by-3 matrix “A.”

Then, the XYZ color space values may be converted to the L*a*b* color space to provide measured L*a*b values.

The RGB color space values, after applying the tone reproduction curves and the 3×3 linear transformation matrix, may also be converted to values in the L*a*b* color space.

A non-linear optimization problem may then be formulated where the objective function may be, for example, the sum of the norm squares of the difference between measured L*a*b* values and the converted L*a*b* values.

This optimization problem may then be solved using any non-linear least squares algorithm.

The independent variables in the optimization problem in accordance with an exemplary embodiment of the present invention are the coefficients of the tone reproduction curve polynomials and the matrix A.

To eliminate one redundant degree of freedom, the sum of the tone reproduction curve polynomial coefficients may be forced to be equal to 1. This also has the benefit that the non-linearity correction maps the value 1 to the value 1. To do this, the coefficients of all but the highest power coefficients are varied independently and the highest power coefficient in the polynomials are set to be equal to (1-sum of the rest of the coefficients).

As explained above, a data point x in a RGB color space may be represented as a vector in three-dimensional space as (x₁, x₂, x₃). This RGB color space data point x may then be converted to a data point y in the XYZ color space. This conversion first requires linearizing each component of the RGB color space data point x to provide a linearized RGB value z which, may be represented as (z₁, z₂, z₃).

The linearization of the RGB color space data may be done using tone reproduction curves, which may be represented as functions f₁, f₂, and f₃.

The relationship between the linearized RGB color space data and the data point x may be represented as:
z₁=f₁(x₁); (4)
z₂=f₂(x₂); and (5)
z₃=f₃(x₃). (6)

This relationship may be compactly represented as:
z=f(x). (7)

The relationship between the linearized RGB color space data z and the non-linear RGB color space data x may also be represented as:
z₁=f₁(x₁, v₁); (8)
z₂=f₂(x₂, v₂); and (9)
z₃=f₃(x₃, v₃). (10)

In this manner, these functions are parameterized by a set of parameters (v₁, v₂, v₃).

For example, the tone reproduction curve functions may be polynomials and each vᵢ would denote the set of coefficients of the polynomial fᵢ.

The linearized RGB value z is then converted to a XYZ color space value y via a 3×3 matrix A where:
y=Az (11)

Given a set of data points xᵢ in RGB color space (either data obtained from a scanner or data to be printed/displayed) and a set of measured XYZ data yᵢ (either measured with colorimetric device, or in the case of a scanner, known values from the calibration chart), a goal of an exemplary embodiment of the present invention may be to find parameters v₁, v₂, v₃ for f₁, f₂, f₃ and the matrix A such that the converted data points xᵢ matches the data points yᵢ in some sense.

In yet another exemplary embodiment, the linear transformation A may be replaced with a nonlinear transformation. For instance, y may be a multivariate polynomial of z. Instead of a 3×3 linear transform, matrix A could be expanded to a M×N matrix multiplying monomials of the components of z.

In one exemplary embodiment of the present invention the differences between the data points xᵢ and the data points yᵢ are optimized in a least square sense. In other words, the parameters of the matrix A and the functions f₁, f₂, f₃ are determined such that they minimize the error function E:

$$E = {\sum }_{i} {‖ Af ( {x}_{i} ) - {y}_{i} ‖}^{2} \qquad ( 12 )$$

where: ∥x∥ is the Euclidean norm of a vector x.

The minimization of this error function results in a non-linear least squares problem which may be solved using a non-linear optimization algorithm.

In an exemplary embodiment of the present invention, the error is measured in the XYZ color space.

In another exemplary embodiment of the present invention, the error may be measured in the L*a*b* color space to take advantage of the better perceptual qualities provided by the L*a*b* color space.

The function g that maps a point in the XYZ color space to a point in the L*a*b* color space, given a specific white point reference, may be found in the conventional literature on color image processing. The error function for measuring the error E in the L*a*b* color space is then:

$$E = {\sum }_{i} {‖ g ( Af ( {x}_{i} ) ) - g ( {y}_{i} ) ‖}^{2} \qquad ( 13 )$$

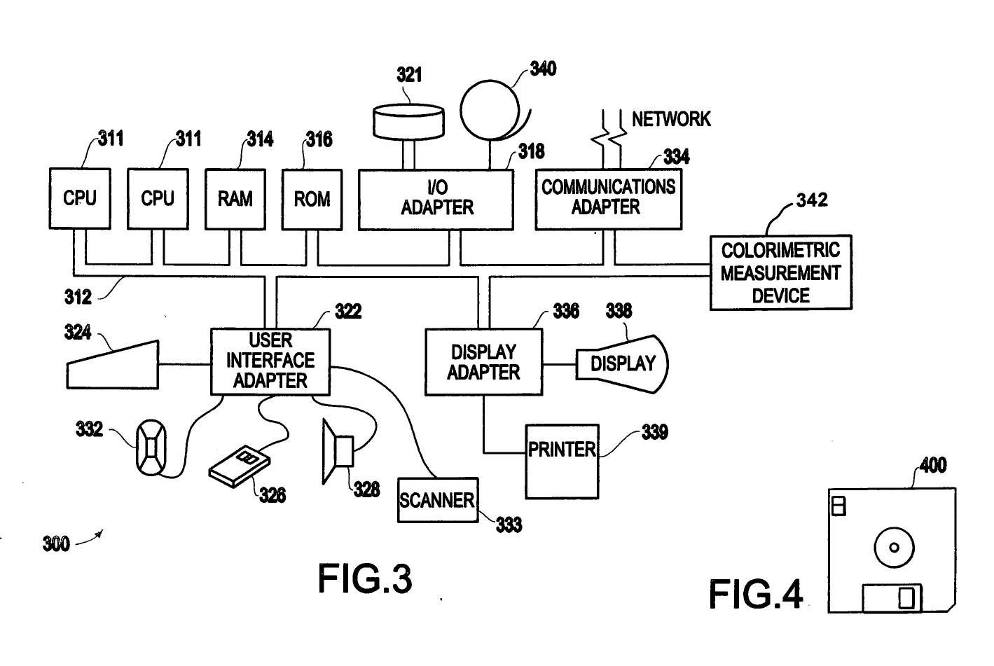

FIG. 3 illustrates a typical hardware configuration of system 300 for use with the invention and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, a scanner 333 and/or other user interface device to the bus 312), a communication adapter 334 for connecting an information handling system to a data processing network, the Internet, an Intranet, a personal area network (PAN), etc., a display adapter 336 for connecting the bus 312 to a display device 338 and/or printer 339, and a colorimetric measurment device 342.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311.

Whether contained in the diskette 400, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method of calibrating a color device, the method comprising:
transforming values in a first color space to obtain values in a second color space; and
minimizing the error between values computed in said second color space and the measured values in said second color space.

2. The method of claim 1, wherein said first color space comprises an RGB color space.

3. The method of claim 1, wherein said second color space comprises a C.I.E. XYZ color space.

4. The method of claim 3, wherein said minimizing of the error comprises:
converting said computed values from said C.I.E. XYZ color space to a C.I.E. L*a*b* color space; and
converting said measured values from said C.I.E. XYZ color space to a C.I.E. L*a*b* color space.

5. The method of claim 1, wherein said transforming comprises simultaneously optimizing non-linear and linear transformations.

6. The method of claim 5, wherein said non-linear transformation comprises a tone reproduction curve polynomial for each channel of said first color space.

7. The method of claim 6, further comprising forcing the sum of the tone reproduction curve polynomial coefficients to equal one.

8. The method of claim 5, wherein said linear transformation comprises a three by three matrix for converting between said first color space and said second color space.

9. The method of claim 5, wherein said linear transformation comprises a M×N matrix for converting between said first color space and said second color space.

10. The method of claim 5, wherein said non-linear transformation comprises a gamma curve polynomial for each channel of said first color space.

11. The method of claim 10, wherein said gamma curve comprises an exponential function.

12. The method of claim 5, wherein said minimizing comprises solving a non-linear optimization problem.

13. The method of claim 12, wherein said non-linear optimization problem comprises the sum of the norm squares of the difference between the measured values and said computed values.

14. The method of claim 1, wherein said computed values are based upon at least one gray scale image.

15. The method of claim 1, wherein said computed values are based upon at least one color image.

16. The method of claim 1, wherein said computed values are based upon at least one normal image.

17. The method of claim 1, wherein said computed values are based upon a measurement by a colorimetric measurement device.

18. The method of claim 17, wherein said measurement by said calorimetric measurement device is based upon a measurement of at least one image that is scanned by a scanner, and wherein said measured color values in said first color space is based upon an output from said scanner of a scan of said at least one image.

19. The method of claim 1, wherein said measured color values in said first color space are based upon a measurement by a calorimetric measurement device.

20. The method of claim 19, wherein said computed values in said second color space are provided as input to one of a color printer and a color display, and wherein said measured color values in said first color space by said measurement by said colorimetric measurement device is based upon a corresponding output from one of said color printer and color display.

21. The method of claim 20, wherein the color device operates in an online state for performing normal image processing while the color device is being calibrated.

22. A system for calibrating a color device, comprising:
means for transforming measured color values in a first color space to obtain measured color values in a second color space; and
means for minimizing the error between values computed in said second color space and the measured color values in said second color space.

23. The system of claim 22, wherein the means for transforming comprises means for simultaneously optimizing non-linear and linear transformations.

24. The system of claim 23, wherein the non-linear transformation comprises a tone reproduction curve polynomial for each channel of the first color space.

25. The system of claim 23, wherein the non-linear transformation comprises a gamma curve polynomial for each channel of the first color space.

26. The system of claim 23, wherein the means for minimizing comprises means for solving a non-linear optimization problem.

27. A method for deploying computing infrastructure, comprising integrating computer-readable code into a computing system, the computer-readable code comprising:
instructions for transforming measured color values in a first color space to obtain measured color values in a second color space; and
instructions for minimizing the error between values computed in said second color space and the measured color values in said second color space.

28. A system for calibrating a color device, comprising:
a first processor that transforms measured color values in a first color space to obtain measured color values in a second color space; and
a second processor that minimizes the error between values computed in said second color space and the measured color values in said second color space.

29. The system of claim 28, wherein the first processor and the second processor comprise the same processor.
